(19) United States
(12) Patent Application Publication
(10) Pub. No.: US 2013/0305078 A1
(43) Pub. Date: Nov. 14, 2013

(54) SYSTEM ON CHIP (SOC), METHOD OF OPERATING THE SOC, AND SYSTEM HAVING THE SOC

(71) Applicants: Heon-Hee Lee, Hwaseong-si (KR); Hoi Jin Lee, Hwaseong-si (KR); Jeong Lae Cho, Hwaseong-si (KR)

(72) Inventors: Heon-Hee Lee, Hwaseong-si (KR); Hoi Jin Lee, Hwaseong-si (KR); Jeong Lae Cho, Hwaseong-si (KR)

(21) Appl. No.: 13/734,176

(22) Filed: Jan. 4, 2013

(30) Foreign Application Priority Data
May 8, 2012 (KR) 102-2012-0048446

(51) Int. Cl. G06F 1/08

(52) U.S. Cl. CPC G06F 1/08
USPC 713/500

(57) ABSTRACT

A data processing system, comprising: a PLL configured to receive a reference clock and to generate a common clock; a processing unit configured to output an operation condition data based on one of temperature, voltage, or process information; and at least two data processing circuits, each comprising: a first clock signal generator configured to receive the common clock signal, the first clock signal generator having a first clock latency adjusting circuit configured to adjust clock signal propagation delay based on the operation condition data; and a second clock signal generator configured to receive the common clock signal, the second clock signal generator having a second clock latency adjusting circuit configured to adjust clock signal propagation delay based on the operation condition data.

### CROSS-REFERENCE TO RELATED APPLICATIONS

This application claims priority under 35 U.S.C. §119(a) from Korean Patent Application No. 10-2012-0048446 filed on May 8, 2012, the disclosure of which is hereby incorporated by reference in its entirety.

### BACKGROUND

Embodiments of the present inventive concept relate to an integrated circuit (IC), and more particularly, to a system on chip (SoC) which may adjust latency between a first clock signal and a second clock signal, a method of operating the SoC, and a system having the SoC.

A semiconductor device such as a system on chip (SoC) having clock driven sequential circuits operates as designed during normal conditions but may suffer from erroneous operations due to varying operating conditions such as different operating frequencies, variation in operating voltages and temperature.

For example, an operating frequency may be f1 when an operating voltage is V1, an operating frequency may be 12 (f2<f1) when the operating voltage is V2 (V2<V1), and an operating frequency may be f3 (f3<f2) when the operating voltage is V3 (V3<V2). For a semiconductor device to process properly data at various operating frequencies, setup time and hold time of the semiconductor device should be designed in consideration of the various operating frequencies.

A designer of a SoC having sequential circuits may need to insert a fixed delay in some of data or clock paths depending on circuit and speed loading of signal paths. This is commonly done by inserting buffers in a data path between sequential circuits in a pipeline. Once implemented within an SoC, the fixed delays are dedicated to the signal paths. If the SoC encounters operating conditions that vary some signal paths or some circuit components more than other signal paths or circuit components, clocking operations may fail. Furthermore, if numerous fixed delays are incorporated in numerous dedicated paths, the SoC size may need to increase, and power consumption will necessarily increase.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a block diagram of a data processing system according to an example embodiment of the present inventive concept;

FIG. 2 is an example embodiment of a latency adjusting circuit illustrated in FIG. 1;

FIG. 3 is an example embodiment of a gating circuit and a delay circuit of the latency adjusting circuit illustrated in FIG. 1;

FIG. 4 is another example embodiment of the latency adjusting circuit illustrated in FIG. 1;

FIG. 5 is a block diagram of the data processing system according to an example embodiment of the present inventive concept;

FIG. 6 is a block diagram of the data processing system according to an example embodiment of the present inventive concept;

FIG. 7 is a block diagram of the data processing system according to an example embodiment of the present inventive concept;

FIG. 8 is a block diagram of the data processing system according to an example embodiment of the present inventive concept;

FIG. 9 is a block diagram illustrating an example embodiment of a system including the data processing system according to an example embodiment of the present inventive concept;

FIG. 10 is a flowchart for explaining an operation of the data processing system according to an example embodiment of the present inventive concept;

FIG. 11 is a block diagram illustrating an example embodiment of the system including the data processing system according to an example embodiment of the present inventive concept; and

FIG. 12 is a block diagram illustrating another example embodiment of the system including the data processing system according to an example embodiment of the present inventive concept.

### SUMMARY

A data processing system is provided, comprising: at least two data processing circuits, each comprising: a first clock signal generator having a first clock latency adjusting circuit configured to adjust clock signal propagation delay based on operation condition data; and a second clock signal generator having a second clock latency adjusting circuit configured to adjust clock signal propagation delay based on operation condition data, wherein the first clock signal generator and the second clock signal generator receive a common clock signal.

According to an embodiment, the first or second clock latency adjusting circuit comprises a plurality of selectable delay paths, each path is configured to provide a different amount of delay from another path.

According to an embodiment, one of the at least two data processing circuits is provided power from a first power domain and another data processing circuit is provided power from a second power domain different from the first power domain. According to an embodiment, the one of the at least two data processing circuits is configured with a reset controlled independently from a reset of another data processing circuit.

According to an embodiment, the operation condition data is one of process, voltage, or temperature condition data. According to an embodiment, the data processing system is embodied in a system on chip (SoC).

According to an embodiment, a PLL is configured to provide the common clock.

According to an embodiment, a processing unit is operatively connected to at least one of a power management unit, a process information unit, or a temperature sensing unit to process operation conditions and output the operation condition data.

According to an embodiment, one of the at least two processing circuits is embodied in a first SoC and another data processing circuit is embodied in a second SoC.

According to an embodiment, the first SoC includes a first PLL and the second SoC includes a second PLL.

A data processing circuit is also provided, comprising: a first clock signal generator having a first clock latency adjusting circuit configured to adjust clock signal propagation delay based on operation condition data; and a second clock signal generator having a second clock latency adjusting circuit configured to adjust clock signal propagation delay based on operation condition data, wherein the first clock signal generator and the second clock signal generator receive a common clock signal.

According to an embodiment, the first or second clock latency adjusting circuit comprises a plurality of selectable delay paths, each path is configured to provide a different amount of delay from another path.

According to an embodiment, a decoder is configured to decode an OCI signal to output a decoded OCI signal to select one of the delay paths, the decoder is configured to receive the OCI signal from an external processing unit.

According to an embodiment, a multiplexer is configured to pass through a clock signal from one of the plurality of delay paths based on the decoded OCI signal.

According to an embodiment, each of the plurality of delay paths is configured with logic circuit and delay gates, the logic circuit is configured to enable passage of the clock signal upon selection by the decoded OCI signal.

According to an embodiment, the plurality of delay paths are formed from different outputs of a serial string of gates.

According to an embodiment, a clock tree configured to distribute a clock input signal over multiple paths, wherein the clock tree is connected between the common clock signal and the first or second clock latency adjusting circuit.

According to an embodiment, a clock tree is configured to distribute a clock input signal over multiple paths, wherein the clock tree is connected to the output of the first or second clock latency adjusting circuit.

According to an embodiment, a plurality of clock trees is provided, each configured to distribute a clock input signal over multiple paths of clock signals, wherein the plurality of clock trees are connected to the output of the first or second clock latency adjusting circuit.

A method of data processing is also provided, comprising: receiving a common clock at a first clock generating circuit and a second clock generating circuit; generating a first clock at the first clock generating circuit by adjusting the clock latency based on operation condition data, the first clock clocking a first sequential logic; and generating a second clock at the second clock generating circuit by adjusting the clock latency based on operation condition data, the second clock clocking a second sequential logic, wherein the adjusting the first or second clock latency includes selecting one of a plurality of selectable delay paths, each path configured to provide a different amount of delay from another path.

According to another provided data processing system, which comprises: a processor including a data processing circuit, comprising: a first clock signal generator having a first clock latency adjusting circuit configured to adjust clock signal propagation delay based on operation condition data; and a second clock signal generator having a second clock latency adjusting circuit configured to adjust clock signal propagation delay based on the operation condition data, wherein the first clock signal generator and the second clock signal generator receive a common clock signal; and an interface block configured to interface the processor with a memory device, a display, and a wireless interface block, wherein the system is embodied in a smartphone, a laptop, or a tablet computer.

According to an embodiment, a first sequential logic circuit having a first clock tree is driven from the output of the first clock signal generator and a second sequential logic circuit having a second clock tree is driven from the output of the second clock signal generator.

According to an embodiment, the first and second clock signal generators are disposed external to the first or second sequential logic circuit.

According to another provided data processing system, which comprises: a PLL configured to receive a reference clock and to generate a common clock; a processing unit configured to output an operation condition data based on one of temperature, voltage, or process information; and at least two data processing circuits, each comprising: a first clock signal generator configured to receive the common clock signal, the first clock signal generator having a first clock latency adjusting circuit configured to adjust clock signal propagation delay based on the operation condition data; and a second clock signal generator configured to receive the common clock signal, the second clock signal generator having a second clock latency adjusting circuit configured to adjust clock signal propagation delay based on the operation condition data.

According to an embodiment, the reference clock is input via an I/O pad.

According to an embodiment, a clock tree configured to receive the common clock signal and distribute the common clock signal over one of multiple paths to the first clock signal generator.

According to an embodiment, a clock tree configured to distribute over multiple paths the latency adjusted clock signal output from the first clock signal generator.

According to an embodiment, the at least two data processing circuits are disposed in two different SoCs.

According to an embodiment, the system is embodied in a smartphone, a laptop, or a tablet computer.

According to an embodiment, a data processing system is provided, comprising: a PLL configured to receive a reference clock and to generate a common clock; a processing unit configured to output an operation condition data based on one of temperature, voltage, or process information; and at least two data processing circuits, each comprising: a first clock signal generator configured to receive the common clock signal, the first clock signal generator having a first clock latency adjusting circuit configured to adjust clock signal propagation delay based on the operation condition data and output a first latency adjusted clock signal; a first clock tree configured to distribute over one of multiple paths the first latency adjusted clock signal to a first sequential logic circuit; a second clock signal generator configured to receive the common clock signal, the second clock signal generator having a second clock latency adjusting circuit configured to adjust clock signal propagation delay based on the operation condition data and output a second latency adjusted clock signal to a second sequential logic circuit; a second clock tree configured to distribute over one of multiple paths the second latency adjusted clock signal to a second sequential logic circuit, wherein the second sequential logic circuit receives data cascaded from the first sequential logic circuit.

### DETAILED DESCRIPTION

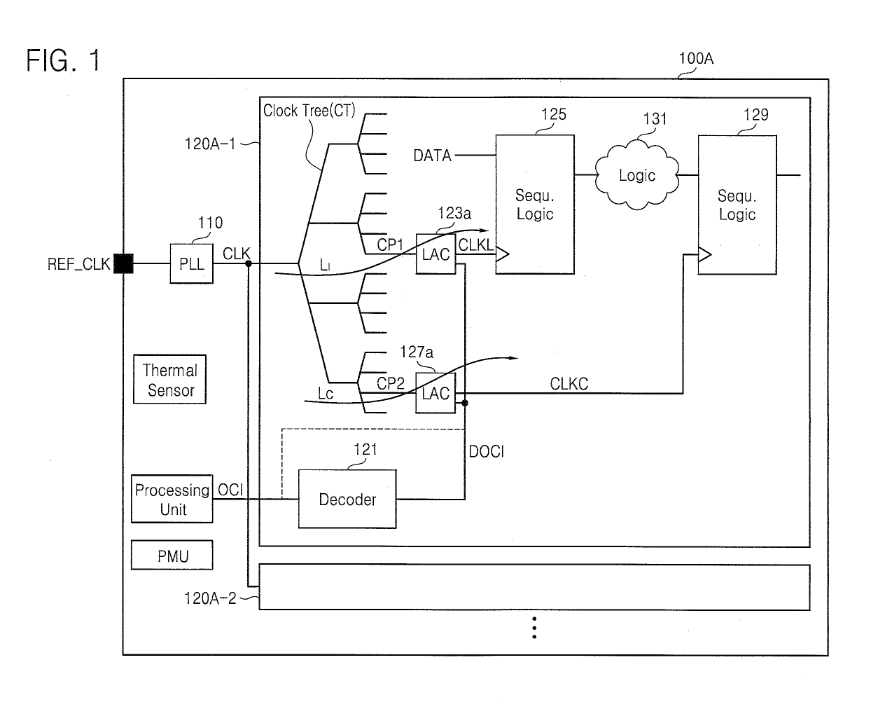

FIG. 1 is a block diagram of a data processing system according to an example embodiment of the present inventive concept. A data processing system 100A includes a phase locked loop (PLL) 110 and at least one of data processing circuits 120A-1, 120A-2 . . . 120A-n (hereafter “DPCs”). The data processing system 100A also includes a processing unit, a power management unit (PMU)[add to FIG. 1], and a thermal sensor. The data processing system 100A according to at least the present embodiment is a synchronous digital system. The data processing system 100A may be embodied as a system on chip (SoC).

Each of the data processing circuit 120A-1, 120A-2, . . . (DPCs) may be embodied in a different power domain. For example, a power or an operating voltage supplied to one power domain may be controlled independently from a power or an operating voltage supplied to another power domain. Also, a reset or a reset operation for the one power domain may be controlled independently from a reset or a reset operation for another power domain.

The PLL 110 may generate a clock signal CLK in response to a reference clock signal REF_CLK output from a clock source. The clock signal CLK serves as a common clock signal for the data processing circuits 120A-1, 120A-2 . . . (DPCs). According to the present embodiment, the REF_CLK signal is received by the PLL 110 through an I/O pad of the data processing system 110A.

According to at least one embodiment of the present inventive concept, each data processing circuit 120A-1, 120A-2, . . . (DPCs) is configured to adjust latency of clock signals that are fanned-out to multiple sequential circuits, for example, the delay, skew, or latency L₁ of a first clock signal CLKL and/or latency Lc of a second clock signal CLKC may be adjusted independently based on different operation condition information OCI and/or based on the stage and/or path latency of a sequential circuit. For purposes of illustrating an embodiment of the present inventive concept, DPCs 120A-1 and 120A-2 are to include the same structure and components and are operated the same. Other DPCs may include different structure and components but share substantially the same clock signal adjusting operations as will be further described herein.

According to at the present embodiment, DPC 120A-1 adjusts clock skew Lc-L₁ of a first clock signal CLKL and a second clock signal CLKC based on operation conditions (e.g., a process condition, a voltage condition and a temperature condition). DPC 120A-1 includes a decoder 121, a clock tree CT, a first clock signal generation circuit 123a, a first sequential logic circuit 125, a second clock signal generation circuit 127a, a second sequential logic circuit 129 and a logic circuit 131. DPC 120A-1 is embodied in a first power domain.

The decoder 121 receives operation condition information OCI from monitors that monitor operation conditions that may affect operational speed of components within data processing system 110A. According to the present embodiment, OCI may be received from one of a thermal sensor that monitors temperature variations, a PMU that monitors voltage variations, such as variations of an operating voltage due to dynamic voltage or frequency scaling, and a Processing Unit that receives process variation information. The process information may be received through a fuse box (not shown) used to select adjustment data indicative of manufacturing and/or process variations. OCI is decoded by the decoder 121 and decoded operation condition information DOCI is generated. According to an alternative example embodiment, the data processing system 100A may include the decoding functions of decoder 121 and DOCI may be output from a processing unit, e.g., a central processing unit (CPU) or a processor core of a multi-core processor, embodied in the SoC 100A.

A clock tree CT distributes a clock signal CLK from a common input and the clock signal CLK is fanned-out to multiple components requiring a clock signal CLK. For example, the clock tree CT may transmit a clock signal CLK to clock sinks through clock tree cells and/or clock gates & buffers.

The clock sinks may be a sequential logic or a sequential element, such as first circuit 125 or second circuit 129, or any like components requiring a clock signal input to synchronize operations. The clock tree CT may also be a clock distribution network or a clock mesh.

A first clock signal generation circuit 123a may adjust the delay or latency L₁ of a clock signal CLK and generate a latency-adjusted first clock signal CLKL based on operation condition information OCI or DOCI and a clock signal CLK input through a first clock path CP1 of the clock tree CT.

The first circuit 125, embodied in a sequential logic circuit, latches input data DATA in response to a first clock signal CLKL.

A second clock signal generation circuit 127a may adjust latency Lc of a clock signal CLK and generate a latency-adjusted second clock signal CLKC based on the operation condition information OCI or DOCI and a clock signal CLK input through a second clock path CP2 of the clock tree CT.

In response to a second clock signal CLKC, the second circuit 129 latches data output from the first circuit 125 through logic 131. The logic 131 may be a combinational logic in a form of a digital logic, which may be embodied by Boolean circuits. As described above, the second circuit 129 may be embodied in a sequential logic circuit. Data output from the second circuit 129 may be transmitted to another sequential logic circuit.

To properly latch data into the second circuit 129 using the clock signal CLKC appearing at its clock input node, the data output from the first circuit through logic 131 must be present prior to the arrival of the clock signal CLKC. For example, the arrival of CLKC has to be delayed by at least the propagation delay time of first circuit 125 and the logic 131, and the setup time of the second circuit 129, after the time of arrival of CLKL at the clock input node of the first circuit 125. It can be seen that different latency or delay may be needed to be applied to different clock paths. On the other hand, if a third circuit (not shown) is connected in the same configuration as the first circuit 125, the latency through respective clock paths may be the same.

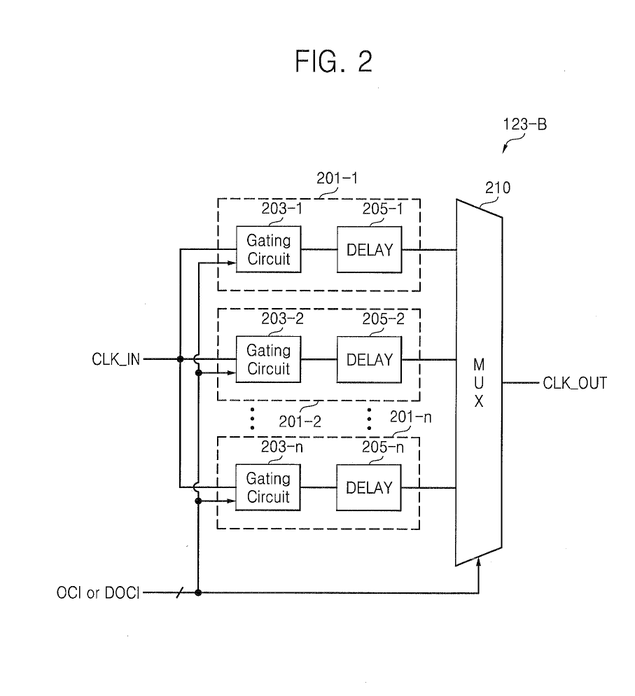

FIG. 2 is an example embodiment of the latency adjusting circuit illustrated in FIG. 1. According to an example embodiment, the number of clock transmission paths of the latency adjusting circuit 123a may be different from the number of clock transmission paths of the latency adjusting circuit 127a.

A structure and an operation of a latency adjusting circuit 123-B is an example embodiment of the latency adjusting circuit 123a illustrated in FIG. 1. The latency adjusting circuit 123-B includes clock transmission paths 201-1 to 201-n (n is a natural number) and a selector 210. Each of the clock transmission paths 201-1 to 201-n receives an input clock signal CLK_IN (=CLK). Each of the clock transmission paths 201-1 to 201-n may have different latency and may be enabled selectively based on operation condition information OCI or DOCI.

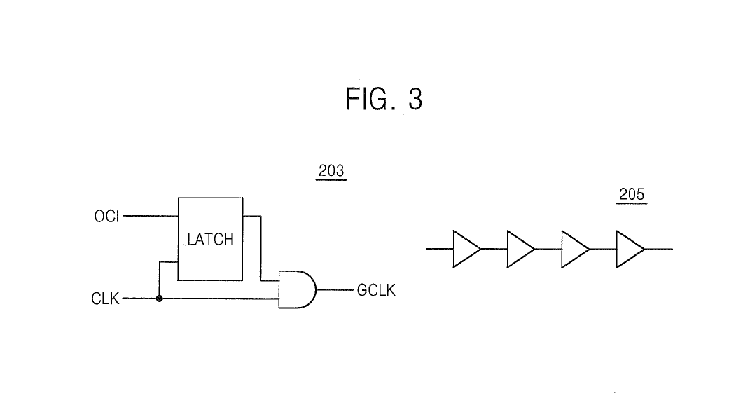

FIG. 3 shows an example embodiment of gating circuit 203 and delay 205. Referring to FIG. 2 and FIG. 3, each clock transmission path 201-1 to 201-n includes corresponding clock gating circuit 203-1 to 203-n and delay circuit 205-1 to 205-n. When a clock gating circuit is embodied in an integrated circuit (IC), the clock gating circuit may be embodied in a form of a clock gating cell. Each clock gating circuit 203-1 to 203-n may transmit or block an input clock signal CLK_IN (=CLK) based on the operation condition information OCI or DOCI.

Each delay circuit 205-1 to 205-n may delay an input clock signal CLK_IN (=CLK) transmitted through each clock gating circuit 203-1 to 203-n. Each clock gating circuit 203-1 may be in the form of a latch to latch OCI or DOCI in response to CLK_IN, and the latched output is gated with CLK_IN to output an ANDed clock signal to be latency adjusted.

Each delay circuit 205-1 to 205-n may be designed to have a different amount of delay. For example, an amount of delay of a delay circuit 205-1, formed from a buffer or buffer chain, having the least delay, and delay circuit 205-2, may comprise an additional buffer or buffer chain, increasing the delay by an amount of, for example, 50 μs. The delay circuit 205-3, increasing delay by another like amount, and so on up to delay circuit 205-n, having the greatest delay. For example, each delay circuit 205-1 to 205-n may be embodied in.

In case, when a first clock gating circuit 203-1 becomes enabled based on operation condition information OCI or DOCI, an input clock signal CLK_IN transmitted through the first clock gating circuit 203-1 is delayed by a first delay circuit 205-1 and a delayed clock signal is output through a selector 210. Here, the rest clock gating circuits 203-2 to 203-n become disabled based on the operation condition information OCI or DOCI, so that each of the rest delay circuits 205-2 to 205-n does not consume a dynamic power.

According to the operation condition information OCI or DOCI, the selector 210 may output selectively an output signal of one of clock transmission paths 201-1 to 201-n. That is, the selector 210 outputs an output signal of an enabled clock transmission path as an output clock signal CLK_OUT. The selector 210 may be embodied in a multiplexer, with the output path selected by the OCI or DOCI signal.

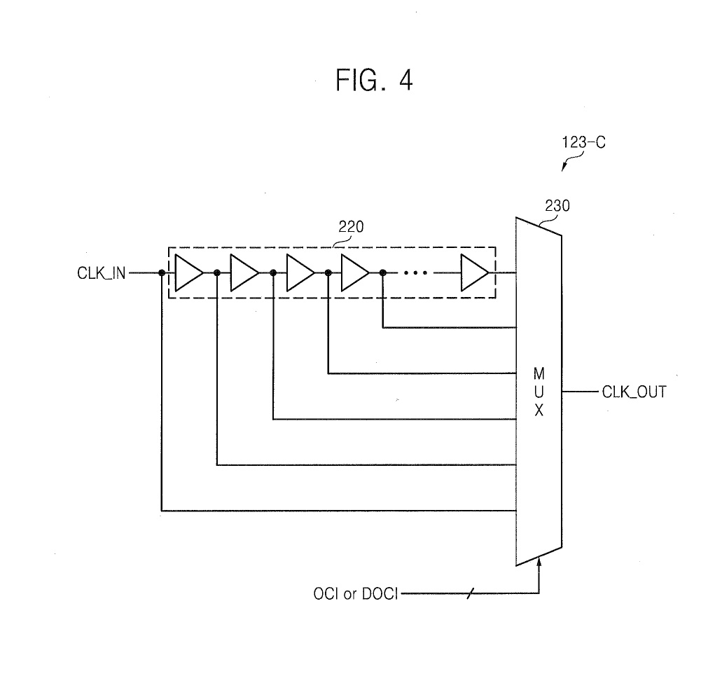

FIG. 4 is another example embodiment of a latency adjusting circuit 123-C. The latency adjusting circuit 123-C includes multiple clock transmission paths, each having a different latency. As shown, latency buffers 220 are stringed for selection at different output nodes, representing different latency. For example, to provide a CLK_OUT having the most latency, the top path is selected and provide a CLK_OUT with the least latency, the bottom path is selected. The outputs of the clock paths are input to a selector 230, which outputs the CLK_OUT signal with the selected latency based on the clock delay path selected by OCI or DOCI. The selector 210 may be embodied in a multiplexer. Each latency adjusting circuit 123a and 127a may be embodied the same as any of latency adjusting circuit 123-B or 123-C described in FIGS. 2 to 4.

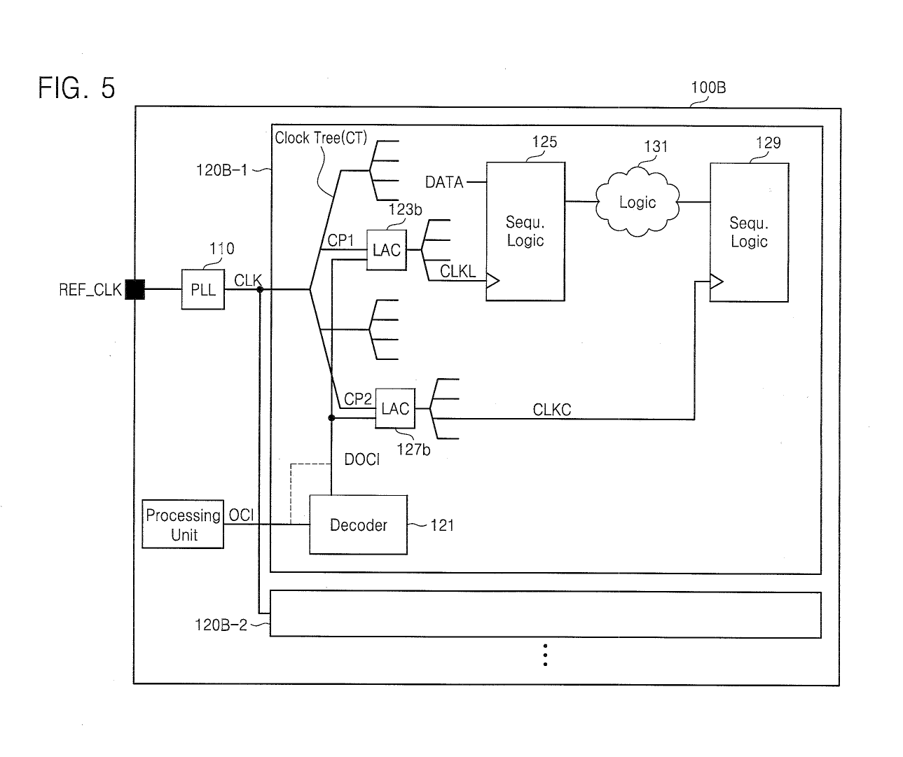

FIG. 5 is a block diagram of a data processing system according to another example embodiment of the present inventive concept. A data processing system 100B includes a PLL 110 and at least one of DPCs 120B-1, 120B-2, . . . 120B-n. Each DPC has substantially the same structure and operation. Each DPC may be embodied in a different power domain. A processing unit receives process information and output OCI data to each DPC. A thermal sensor and a power management unit (not shown) provide further operating condition data to form OCI data. The data processing system 100B may be embodied in a SoC.

Latency adjusting circuit 123b and 127b, having structure and operation as above described for 123a and 127a, may adjust clock skew Lc to L₁ (=Lc−L₁) by adjusting each latency L1 and Lc based on operation condition information OCI or DOCI. For example, each latency adjusting circuit 123b and 127b may adjust clock skew Lc-L₁ when a DPC operates with a first voltage (or a clock signal CLK having first frequency) and clock skew Lc−L₁ when the DPC operates with a second voltage (or a clock signal CLK having a second frequency) differently according to the operation condition information OCI or DOCI. The data processing system 100B of FIG. 5 includes multiple clock trees (CT) to fan out the common clock signal CLK. According to the present embodiment, the latency adjusting circuit 123b is disposed before a clock tree (CT), so that multiple copies of latency adjusted clock signal CLKL is made available for a group of sequential circuits such as first circuit 125. Similarly, the latency adjusting circuit 127b is disposed before a clock tree (CT), so that multiple copies of latency adjusted clock signal CLKC is made available for a group of sequential circuits such as second circuit 129.

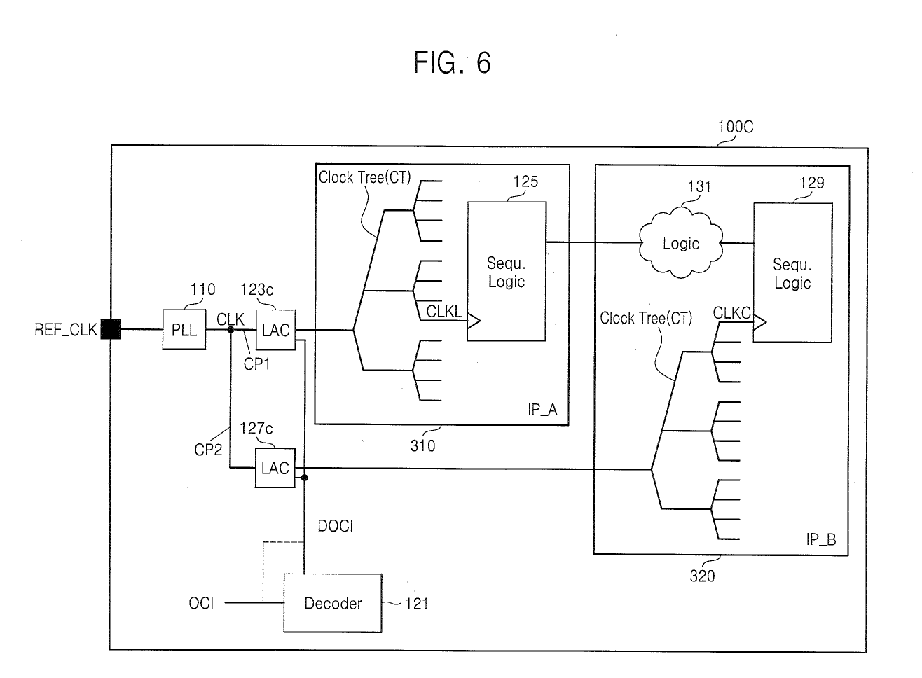

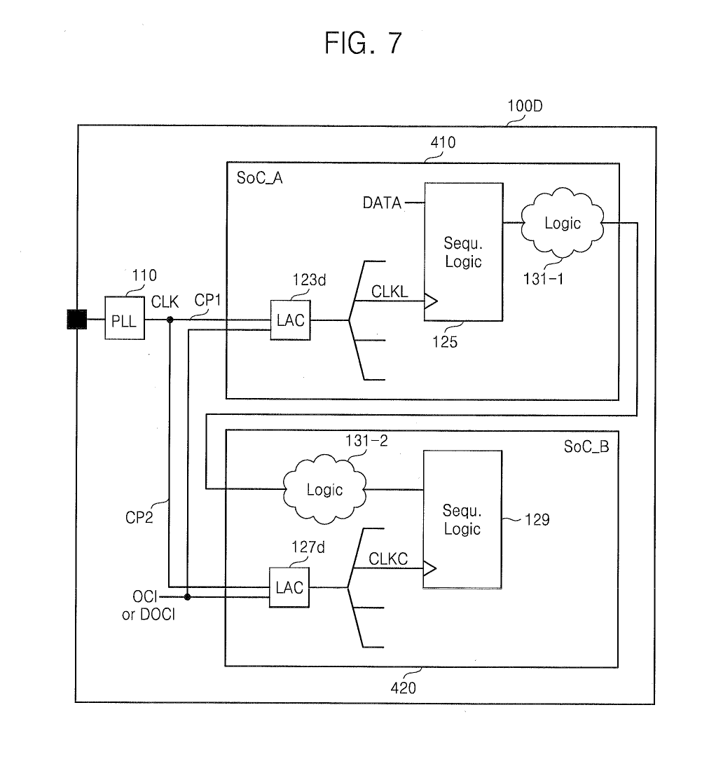

FIG. 6 illustrates a block diagram of a data processing system according to another example embodiment of the present inventive concept. Referring to FIG. 7, a data processing system 100C includes a PLL 110, a decoder 121, a first clock signal generation circuit 123c, a second clock signal generation circuit 127c, a first intellectual property (IP) 310 and a second IP 320. Each IP serves as a function block used in a SoC 100C and may include a central processing unit (CPU), a processor, each core of a multi-core processor, a memory, a universal serial bus (USB), a peripheral component interconnect (PCI), a digital signal processor (DSP), a wired interface, a wireless interface, a controller, an embedded software, a codec, a video module (e.g., a camera interface, a Joint Photographic Experts Group (JPEG) processor, a video processor or a mixer), a 3-dimensional graphic core, an audio system or a driver, etc.

Based on operation condition information OCT or DOCI output from a processing unit, a first clock signal generation circuit 123c adjusts latency of a clock signal CLK input through a first clock path CP1 and generates a latency adjusted first clock signal CLKL. The first clock signal CLKL is input to the first circuit 125 through a clock tree CT embodied in a first IP 310. The first circuit 125 launches input data in response to the first clock signal CLKL.

Based on the operation condition information OCI or DOCI, a second clock signal generation circuit 127c adjusts latency of a clock signal CLK input through a second clock path CP2 and generates a latency adjusted second clock signal CLKC. A second clock signal CLKC is input to the second circuit 129 through a clock tree CT embodied in a second IP 320. The second circuit 129 captures output data of the logic 131 in response to the second clock signal CLKC. According to an alternative example embodiment, the first clock signal generation circuit 123c and/or the second clock signal generation circuit 127c may be embodied within IP 310 and/or 320. Each IP may be embodied in a different domain.

FIG. 7 is a block diagram of a data processing system according to another example embodiment of the present inventive concept. Referring to FIG. 7, a data processing system 100D includes a PLL 110, a first SoC 410 and a second SoC 420. Here, the data processing system 100D may be embodied in a system in package (SiP) or a package on package (PoP), etc.

Each SoC 410 and SoC 420 may be formed on the same silicon or on different wafers. Based on operation condition information OCI or DOCI output from a processing unit, a first clock signal generation circuit 123d of the first SoC 410 adjusts latency of a clock signal CLK input through a first clock path CP1 and generates a latency-adjusted clock signal CLKL, for example a first clock signal CLKL.

The first clock signal CLKL is input to the first circuit 125 through a clock tree CT embodied in the first SoC 410.

Based on the operation condition information OCI or DOCI output from the processing unit, a second clock signal generation circuit 127d adjusts latency of a clock signal CLK input through a second clock path CP2 and generates a latency-adjusted clock signal CLKC, for example a second clock signal CLKC.

The second clock signal CLKC is input to the second circuit 129 through a clock tree CT embodied in the second SoC 420. The second circuit 129 seconds data transmitted through at least one logic 131-1 and 131-2 in response to the second clock signal CLKC.

According to an alternative embodiment, a clock tree can be disposed before either or both first and second clock signal generation circuit 123d and 127d. The PLL 110 may also be disposed within each or both SoC 410 and SoC 420.

As illustrated in FIGS. 1, 5, 6 and 7, a domain generating or transmitting a first clock signal CLKL may be different from a domain generating or transmitting a second clock signal CLKC. Here, a domain may mean a power domain, an IP, or an SoC.

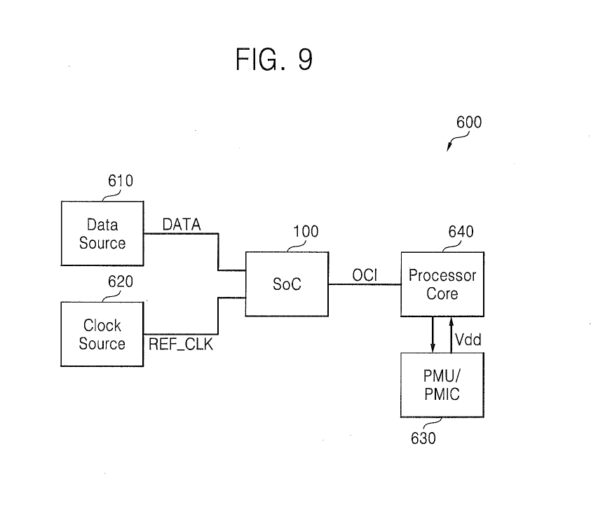

FIG. 9 is a block diagram of a data processing system according to another example embodiment of the present inventive concept. Referring to FIG. 9, an SoC 100E includes the decoder 121, a first clock signal generation circuit 123e, a first circuit 125, a second clock signal generation circuit 127e-1, a third signal generation circuit 127e-2, a first data latency adjusting circuit 510, a second data latency adjusting circuit 520, a second circuit 129-1 and a third circuit 129-2. According to operation condition information OCI or DOCI, the SoC 100E may adjust not only latency of a clock signal CLK supplied to each clock signal generation circuit 123e, 127e-1 and 127e-2, but also latency of each data input to each second circuit 129-1 and third circuit 129-2.

The first clock signal generation circuit 123e may adjust latency of a clock signal CLK based on operation condition information OCI or DOCI and generate a latency adjusted first clock signal CLKL. The first circuit 125 launches input data in response to the first clock signal CLKL.

A second clock signal generation circuit 127e-1 may adjust latency of a clock signal CLK according to operation condition information OCI or DOCI and generate a second clock signal. A second clock signal generation circuit 127e-2 may adjust latency of a clock signal CLK according to operation condition information OCI or DOCI and generate a second clock signal.

Latency adjusted by the second clock signal generation circuit 127e-1 may be the same or different from latency adjusted by the third clock signal generation circuit 127e-2.

A first data latency adjusting circuit 510 receives output data of the logic 131 processing output data of the first circuit 125 and adjusts latency of received data based on operation condition information OCI or DOCI. A second data latency adjusting circuit 520 receives output data of the logic 131 processing output data of the first circuit 125 and adjusts latency of received data based on operation condition information OCI or DOCI. Latency adjusted by the first data latency adjusting circuit 510 may be the same or different from latency adjusted by the second data latency adjusting circuit 520.

A second circuit 129-1 captures output data of the first data latency adjusting circuit 510 in response to a second clock signal output from the second clock signal generation circuit 127e-1. A third circuit 129-2 captures output data of the second data latency adjusting circuit 520 in response to a third clock signal output from the third clock signal generation circuit 127e-2.

FIG. 9 is a block diagram illustrating an example embodiment of a system including a data processing system 100 according to any of example embodiments of the present inventive concept described above. A system 600 may mean a synchronous digital system and be embodied in a personal computer (PC) or a portable device.

The portable device may be embodied in a laptop computer, a cellular phone, a smart phone, a tablet PC, a personal digital assistant (PDA), an enterprise digital assistant (EDA), a digital still camera, a digital video camera, a portable multimedia player (PMP), a personal navigation device or a portable navigation device (PND), a handheld game console, or an e-book.

The system 600 includes a data source 610, a clock source 620 and a data processing system from any of 100A to 100E (collectively ‘100’). The system 600 may further include a power management unit 630 and a processing unit 640, e.g., a processing core. The power management unit 630 may be replaced with a power management IC (PMIC).

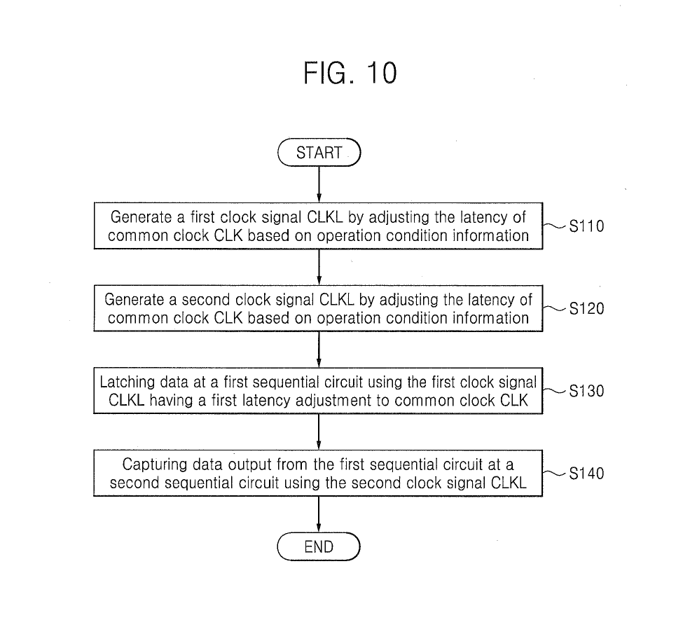

For convenience of explanation, the power management unit 630 and the processing unit 640 are illustrated outside of the data processing system 100 in FIG. 10; however, at least one of the power management unit 630 and the processing unit 640 may be embodied in the data processing system 100.

A data source 610 outputs data to be processed. The data source 610 may be embodied in a volatile memory device or a non-volatile memory device. A clock source 620 generates a reference clock signal REF_CLK.

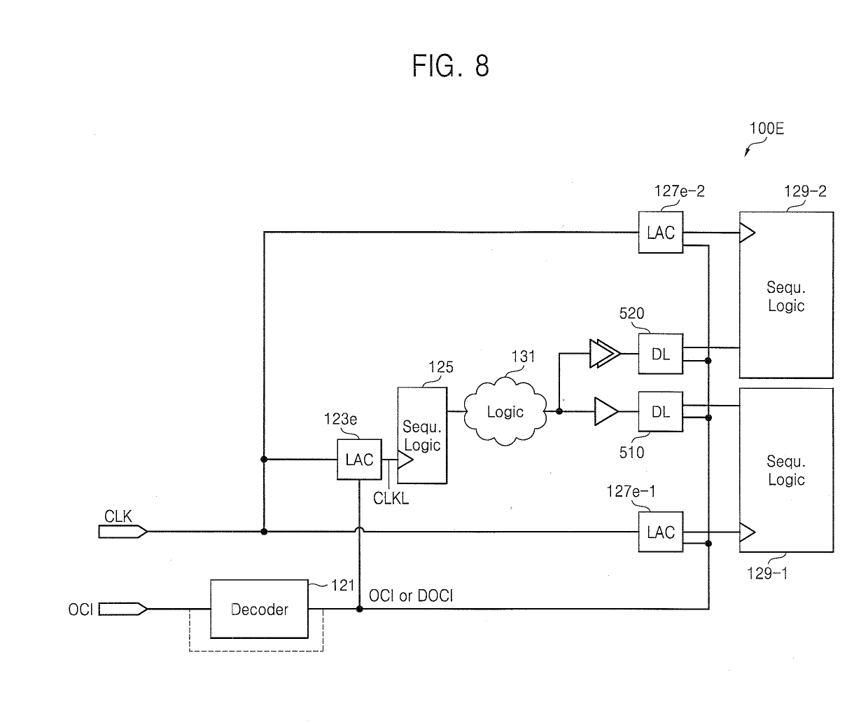

A structure and an operation of the data processing system 100 are the same as explained referring to FIGS. 1 to 9.

For convenience of explanation, the data source 610 and the clock source 620 are illustrated outside of the data processing system 100 in FIG. 10; however, at least one of the data source 610 and the clock source 620 may be integrated in the data processing system 100.

The power management unit 630 may control a voltage Vdd supplied to the processing unit 640 and/or to the data processing system 100 under the control of the processing unit 640. The processing unit 640 may supply operation condition information OCI to the data processing system 100 based on an output voltage Vdd of the power management unit 630. In addition, the system 600 may control an operation of the clock source 620 under the control of the processing unit 640. Accordingly, the clock source 620 may control a frequency of a reference clock signal REF_CLK according to control of the processing unit 640.

According to an example embodiment, the processing unit 640 may change a frequency of a clock signal CLK by controlling an operation of the PLL 110.

FIG. 10 is a flowchart for explaining an operation of the data processing system according to an example embodiment of the present inventive concept. Referring to FIGS. 1 to 10, the data processing system 100A to 100E (collectively ‘100’) generates a first clock signal CLKL by adjusting the latency of common clock CLK based on operation condition information OCI or DOCI (S 110); and generates a second clock signal CLKC by adjusting the latency of common clock CLK based on operation condition information OCI or DOCI (S120); latching data at a first sequential circuit using the first clock signal CLKL having a first latency adjustment to common clock CLK (S 130); capturing data output from the first sequential circuit at a second sequential circuit using the second clock signal CLKC (S 140).

The data processing system 100 may adjust clock skew between the first clock signal CLKL and the second clock signal CLKC differently by an operation condition corresponding to operation condition information OCI or DOCI.

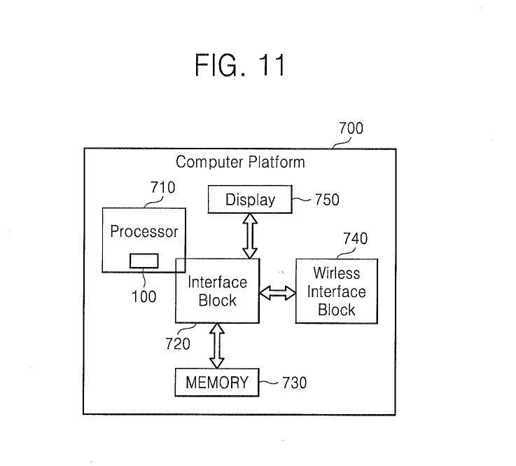

FIG. 11 is a block diagram illustrating a system including a data processing system 100 according to any of example embodiments described above.

A computer platform 700 may be used in an electronic device such as a PC or a handheld (or portable) device.

The computer platform 700 includes a processor 710, an interface block 720 and a memory 730. According to an example embodiment, the computer platform 700 may further include at least one of a wireless interface block 740 and a display 750.

A processor 710 including one or more cores may include the data processing system 100. The processor 710 may communicate with the memory 730, the wireless interface block 740 or the display 750 through the interface block 720. The interface block 720 includes one or more circuit blocks which may perform various interface control functions. The control functions include a memory access control, a graphic control, an input/output interface control or a wireless network access control.

Each of the circuit blocks may be embodied in an additional independent chip, a part of the processor 710, or inside of the processor 710.

The memory 730 may transmit or receive data to/from the processor 710 through the interface block 720. The wireless interface block 740 may connect the computer platform 700 to a wireless network, e.g., a mobile communication network or a wireless local area network (LAN), through an antenna.

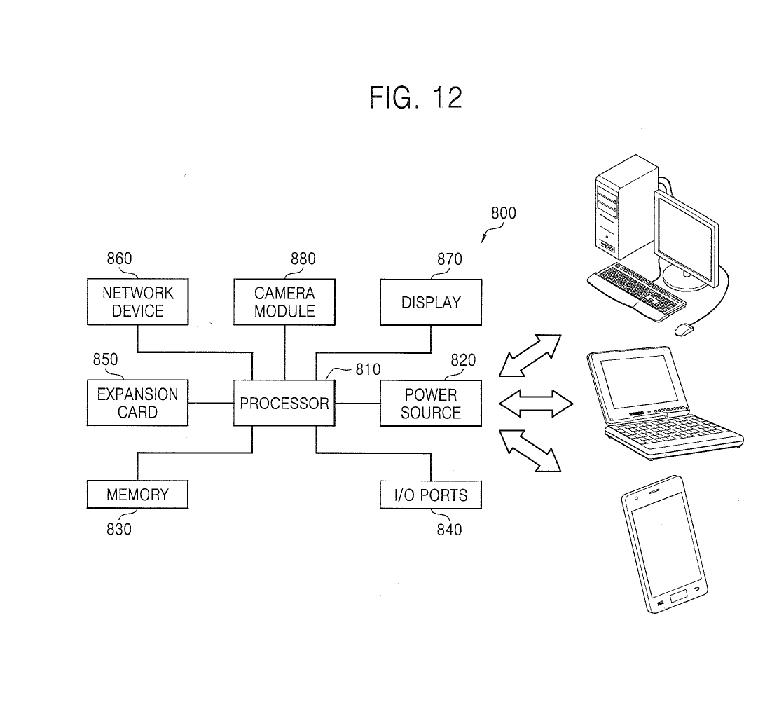

FIG. 12 is a block diagram depicting another system including the data processing system 100 according to any of the example embodiments described above. Referring to FIG. 12, a system 800 may be embodied in a PC, a data server, a laptop computer or a handheld device.

The system 800 includes a processor 810, a power source 820, a memory 830, input/output ports 840, an expansion card 850, a network device 860, and a display 870. According to an example embodiment, the system 800 may further include a camera module 880. The data processing system 100 may be built in at least one of elements 810 to 880.

The processor 810 may control an operation of at least one of elements 820 to 880. The power source 820 may supply an operating voltage to at least one of elements 810 and 830 to 880.

The memory 830 may be embodied in a volatile memory or a non-volatile memory. According to an example embodiment, a memory controller which may control a data access operation for the memory 830, e.g., a read operation, a write operation (or a program operation), or an erase operation, may be integrated or built in the processor 810. According to another example embodiment, the memory controller may be embodied between the processor 810 and the memory 830.

The input/output ports 840 means ports which may transmit data to the system 800 or transmit data output from the system 800 to an external device. For example, the input/output ports 840 may be a port for connecting a pointing device like a computer mouse, a printer or a USB driver.

The expansion card 850 may be embodied in a secure digital (SD) card or a multimedia card (MMC) card. According to an example embodiment, the expansion card 850 may be a Subscriber Identification Module (SIM) card or a Universal Subscriber Identity Module (USIM) card. The network device 860 means a device which may connect the system 800 to a wire network or a wireless network.

The display 870 may display data output from the memory 830, the input/output ports 840, the expansion card 850 or the network device 860. The camera module 880 means a module which may convert an optical image into an electric image. Accordingly, an electric image output from the camera module 880 may be stored in the memory 830 or the expansion card 850. In addition, an electric image output from the camera module 880 may be displayed through the display 870.

Each circuit 123a to 123e (collectively, ‘123’) has substantially the same structure and each circuit 127a to 127d, 127e-1 and 127e-2 (collectively, ‘127’) has substantially the same structure. Each circuit 510 and 520 has substantially the same structure. In addition, each circuit 123, 127, 510 and 520 has substantially the same structure.

In addition, the number of clock transmission paths of the circuit 123 for adjusting latency of a clock signal CLK may be the same or different from the number of clock transmission paths of the circuit 127 for adjusting latency of a clock signal CLK.

An apparatus and a method according to an example embodiment of the present inventive concept may have an operating speed that may be maximized at a high voltage, maintain a data path delay as it is when fixing hold time and/or setup time at a low voltage, and adjust latency of a clock signal by operating voltages and/or operating temperatures.

Although embodiments of the present inventive concept have been shown and described, it will be appreciated by those skilled in the art that changes may be made in these embodiments without departing from the principles and spirit of the general inventive concept, the scope of which is defined in the appended claims and their equivalents.

We claim:

1. A data processing system, comprising:
at least two data processing circuits, each comprising:
a first clock signal generator having a first clock latency adjusting circuit configured to adjust clock signal propagation delay based on operation condition data; and
a second clock signal generator having a second clock latency adjusting circuit configured to adjust clock signal propagation delay based on the operation condition data,
wherein the first clock signal generator and the second clock signal generator receive a common clock signal.

2. The system of claim 1, wherein the first or second clock latency adjusting circuit comprises a plurality of selectable delay paths, each path is configured to provide a different amount of delay from another path.

3. The system of claim 2, wherein one of the at least two data processing circuits is provided power from a first power domain and another data processing circuit is provided power from a second power domain different from the first power domain.

4. The system of claim 1, wherein the one of the at least two data processing circuits is configured with a reset controlled independently from a reset of another data processing circuit.

5. The system of claim 1, wherein the operation condition data is one of process, voltage, or temperature condition data.

6. The system of claim 1, wherein the data processing system is embodied in a system on chip (SoC).

7. The system of claim 1, further including a PLL configured to provide the common clock.

8. The system of claim 1, further including a processing unit operatively connected to at least one of a power management unit, a process information unit, or a temperature sensing unit to process operation conditions and output the operation condition data.

9. The system of claim 1, wherein one of the at least two processing circuits is embodied in a first SoC and another data processing circuit is embodied in a second SoC.

10. The system of claim 9, wherein the first SoC includes a first PLL and the second SoC includes a second PLL.

11. A data processing circuit, comprising:
a first clock signal generator having a first clock latency adjusting circuit configured to adjust clock signal propagation delay based on operation condition data; and
a second clock signal generator having a second clock latency adjusting circuit configured to adjust clock signal propagation delay based on operation condition data,
wherein the first clock signal generator and the second clock signal generator receive a common clock signal.

12. The circuit of claim 11, wherein the first or second clock latency adjusting circuit comprises a plurality of selectable delay paths, each path is configured to provide a different amount of delay from another path.

13. The circuit of claim 12, further including a decoder configured to decode an OCI signal to output a decoded OCI signal to select one of the delay paths, the decoder is configured to receive the OCI signal from an external processing unit.

14. The circuit of claim 13, further including a multiplexer configured to pass through a clock signal from one of the plurality of delay paths based on the decoded OCI signal.

15. The circuit of claim 13, wherein each of the plurality of delay paths is configured with logic circuit and delay gates, the logic circuit is configured to enable passage of the clock signal upon selection by the decoded OCI signal.

16. The circuit of claim 12, wherein the plurality of delay paths are formed from different outputs of a serial string of gates.

17. The circuit of claim 11, further including a clock tree configured to distribute a clock input signal over multiple paths, wherein the clock tree is connected between the common clock signal and the first or second clock latency adjusting circuit.

18. The circuit of claim 11, further including a clock tree configured to distribute a clock input signal over multiple paths, wherein the clock tree is connected to the output of the first or second clock latency adjusting circuit.

19. The circuit of claim 11, further including a plurality of clock trees, each configured to distribute a clock input signal over multiple paths of clock signals, wherein the plurality of clock trees are connected to the output of the first or second clock latency adjusting circuit.

20. The circuit of claim 11, wherein the operation condition data is one of process, voltage, or temperature condition data.

21. A method of data processing, comprising:
receiving a common clock at a first clock generating circuit and a second clock generating circuit;
generating a first clock at the first clock generating circuit by adjusting the clock latency based on operation condition data, the first clock clocking a first sequential logic; and
generating a second clock at the second clock generating circuit by adjusting the clock latency based on operation condition data, the second clock clocking a second sequential logic;
wherein the adjusting the first or second clock latency includes selecting one of a plurality of selectable delay paths, each path configured to provide a different amount of delay from another path.

22. The method of claim 21, further including generating the common clock from a reference clock using a PLL.

23. The method of claim 22, wherein the reference clock is received via an I/O pad.

24. The method of claim 21, wherein the operation condition data is one of process, voltage, or temperature condition data.

25. The method of claim 21, wherein the amount of clock latency adjusted by the first clock generating circuit is different than the amount of clock latency adjusted by the second clock generating circuit.

26. The method of claim 21, wherein the common clock is received at the first clock generating circuit through one of a plurality of clock output paths of a clock tree.

27. The method of claim 21, wherein a clock signal generated by the first clock generating circuit is distributed over a plurality of clock paths of a clock tree.

28. The method of claim 21, wherein a clock signal generated by the second clock generating circuit is distributed over a plurality of clock paths of a second clock tree.

29. The method of claim 21, wherein power is provided to the first clock signal generating circuit via a first power domain and power is provided to the second clock signal generating circuit via a second power domain different from the first power domain.

30. The method of claim 21, wherein the common clock is received at the first clock generating circuit in a first SoC and the common clock is received at the second clock generating circuit in a second SoC different from the first SoC.

31. A data processing system, comprising:
a processor including a data processing circuit, comprising:
a first clock signal generator having a first clock latency adjusting circuit configured to adjust clock signal propagation delay based on operation condition data; and
a second clock signal generator having a second clock latency adjusting circuit configured to adjust clock signal propagation delay based on the operation condition data,
wherein the first clock signal generator and the second clock signal generator receive a common clock signal; and
an interface block configured to interface the processor with a memory device, a display, and a wireless interface block.

32. The system of claim 31, wherein the system is embodied in a smartphone, a laptop, or a tablet computer.

33. The system of claim 31, further including a first sequential logic circuit having a first clock tree driven from the output of the first clock signal generator and a second sequential logic circuit having a second clock tree driven from the output of the second clock signal generator.

34. The system of claim 33, wherein the first and second clock signal generators are disposed external to the first or second sequential logic circuit.

35. A data processing system, comprising:
a PLL configured to receive a reference clock and to generate a common clock;
a processing unit configured to output an operation condition data based on one of temperature, voltage, or process information; and
at least two data processing circuits, each comprising:
a first clock signal generator configured to receive the common clock signal, the first clock signal generator having a first clock latency adjusting circuit configured to adjust clock signal propagation delay based on the operation condition data; and
a second clock signal generator configured to receive the common clock signal, the second clock signal generator having a second clock latency adjusting circuit configured to adjust clock signal propagation delay based on the operation condition data.

36. The system of claim 35, wherein the reference clock is input via an I/O pad.

37. The system of claim 35, further including a clock tree configured to receive the common clock signal and distribute the common clock signal over one of multiple paths to the first clock signal generator.

38. The system of claim 35, further including a clock tree configured to distribute over multiple paths the latency adjusted clock signal output from the first clock signal generator.

39. The system of claim 35, wherein the at least two data processing circuits are disposed in two different SoCs.

40. The system of claim 39, wherein the system is embodied in a system in package SiP.

41. The system of claim 39, wherein each SoC includes the PLL.

42. The system of claim 35, wherein the system is embodied in a smartphone, a laptop, or a tablet computer.

43. A data processing system, comprising:
a PLL configured to receive a reference clock and to generate a common clock;
a processing unit configured to output an operation condition data based on one of temperature, voltage, or process information; and
at least two data processing circuits, each comprising:
a first clock signal generator configured to receive the common clock signal, the first clock signal generator having a first clock latency adjusting circuit configured to adjust clock signal propagation delay based on the operation condition data and output a first latency adjusted clock signal;
a first clock tree configured to distribute over one of multiple paths the first latency adjusted clock signal to a first sequential logic circuit;
a second clock signal generator configured to receive the common clock signal, the second clock signal generator having a second clock latency adjusting circuit configured to adjust clock signal propagation delay based on the operation condition data and output a second latency adjusted clock signal to a second sequential logic circuit;
a second clock tree configured to distribute over one of multiple paths the second latency adjusted clock signal to a second sequential logic circuit,
wherein the second sequential logic circuit receives data cascaded from the first sequential logic circuit.

44. The system of claim 41, wherein the system is embodied in a smartphone, a laptop, or a tablet computer.

45. A data processing system, comprising:
a PLL configured to receive a reference clock and to generate a common clock;
a processing unit configured to output an operation condition data based on one of temperature, voltage, or process information; and
a first clock signal generator configured to receive the common clock signal, the first clock signal generator having a first clock latency adjusting circuit configured to adjust clock signal propagation delay based on the operation condition data and output a first latency adjusted clock signal;
a first intellectual property comprising a first plurality of clock trees and a first plurality of sequential circuits, wherein a first clock tree is configured to distribute over one of multiple paths the first latency adjusted clock signal to a first sequential logic circuit;
a second clock signal generator configured to receive the common clock signal, the second clock signal generator having a second clock latency adjusting circuit configured to adjust clock signal propagation delay based on the operation condition data and output a second latency adjusted clock signal to a second sequential logic circuit;
a second intellectual property comprising a second plurality of clock trees and a second plurality of sequential circuits, wherein a second clock tree is configured to distribute over one of multiple paths the second latency adjusted clock signal to a second sequential circuit,
wherein the second sequential logic circuit receives data cascaded from the first sequential logic circuit.
